(19) United States
(12) Patent Application Publication
(10) Pub. No.: US 2003/0128099 A1
(43) Pub. Date: Jul. 10, 2003

(54) System and method for securing a defined perimeter using multi-layered biometric electronic processing

(76) Inventor: John M. Cockerham, Huntsville, AL (US)

Correspondence Address: ROBERTS ABOKHAIR & MARDULA, SUITE 1000, 11800 SUNRISE VALLEY DRIVE, RESTON, VA, 20191, US

(21) Appl. No.: 10/255,798

(22) Filed: Sep. 26, 2002

Related U.S. Application Data
(60) Provisional application No. 60/324,885, filed on Sep. 26, 2001.

(51) Int. Cl. H04Q 1/00

(52) U.S. Cl. 340/5.7; 340/5.82

(57) ABSTRACT

A system and method for securing a defined perimeter using multi-layered biometric electronic processing. The present invention provides means for authorizing objects to enter a defined perimeter, for assigning an object access rights to zones within a defined perimeter, and for monitoring and tracking objects within the defined perimeter without undue intrusion or delay. A private biometric and a public biometric are used to identify a human object to allow the human object to enter a defined perimeter. The public biometric is used monitor the movement of a human object within zones and to identify human objects that are in violation of their assigned access rights. In an air transportation system, the defined perimeter comprises all airport, airport terminals and facilities within the system.

### CROSS REFERENCE TO RELATED APPLICATIONS

This application claims priority under 35 U.S.C. § 119(e) from provisional application No. 60/324,885, filed Sep. 26, 2001. The 60/324,885 provisional application is incorporated by reference herein, in its entirety, for all purposes.

### FIELD OF THE INVENTION

This invention relates to facility security and more specifically to security systems using biometric identifications.

### BACKGROUND OF THE INVENTION

For many years airport security has been virtually nonexistent. Most of the visible acts of security have been done to the benefit of the customer's perception. The security methods depend on human judgment in their application and physical screening methods of undesirable objects to identify undesirable people. Air travel employees use badges, pin numbers and passwords that are worthless measures against serious attacks on security. Hiring practices do little to screen out potential security risk individuals and the actual security workers are most often minimum wage employees furnished by competing contractors. There is little training of security workers and there are substantial variations in the security between airport installations.

The air travel security concept has relied on showing physical presence, bolstering the perception that more inconvenience produces more security, and disarming all passengers and the crew. The system makes no attempt to screen out criminals and terrorists from flying unless they are caught in the act of a security violation. The system is truly open to all comers.

On Sep. 11, 2001 our air travel security system was revealed as weak and porous. The suggested immediate fix is more of the same . . . more questions and searches of everyone, more inconvenience and delay but incrementally little or no improved security.

Worldwide acts of terror have underscored the need for improved security, not only at airports, but within any defined perimeter. However, security must not unduly impede the orderly pursuit of legitimate interests. For example, while there is a need to make air travel desirable for customers, security that imposes harsh burdens on the airport using public, driving clients away with no security improvement is not an acceptable solution. Thus we need methods that actually yield more security but with less presence and inconvenience. This begins with clearly identifying the threats and placing the elimination of those threats above all other priorities. What is needed is a consistent level and application of security throughout a defined perimeter that excludes those who are determined to be undesirable without impeding others. In the context of a transportation system, an approach that unobtrusively and quickly screens out the very low risk travelers allows more resources to be applied to identify and deal with higher risk travelers. Actual security can be made better, more consistent, faster and less costly.

An integrated database and security process would take into account all the objects that enter the transportation system, wherein an object may be a human living object, a non-human living object, or an inanimate object. (For clarity, non-human living objects and inanimate objects will be referred to as “property objects” and human living objects as “human objects”.) Passengers, baggage, cargo, guests, flight crews, service providers, law enforcement personnel, vendors and security personnel need be tracked as they enter and leave the transportation system. Passenger and baggage should be monitored as they enter new transportation facilities in transit.

### SUMMARY OF THE INVENTION

An embodiment of the present invention is a security system for a defined perimeter. Security rules are defined for objects that enter a perimeter wherein an object may be a human object or a property object. A perimeter comprises zones where different security rules apply to different objects. An object enters a perimeter and zones, and traverses zones, based on permissions granted the object. In another embodiment of the present invention, the defined perimeter is Air System comprising a plurality of airports and related facilities.

The present invention comprises a central perimeter database and processor in network with work terminals, electronic pass cards, proximity tags, biometric measuring devices, scanners and readers to read the digital contents of the passes and proximity tags and surveillance cameras. The central perimeter database is also in network with databases throughout the country.

Electronic security passes are issued for each person entering the defined perimeter. The individual carries the pass with him as he traverses the defined perimeter. The defined perimeter is separated into zones. Each zone has differing security levels and the security pass contains the zone access permissions along with other data. Included in the present invention is a means to scan or read the passes, thus the central perimeter database can track all the occupants within the defined perimeter. Logic in the central processor also contains logic to detect security violations and suspicious behavior. Upon some threshold event, a warning and alarm is generated. Security cameras are also employed in monitoring people flow within the defined perimeter.

Security data written to the security pass includes biometric measurements such as fingerprint codes and facial geometry codes. The biometric measurements are used to confirm the identity of the pass holder. The proximate tags are used to track baggage and to identify the owner of the baggage.

It is therefore an object of the present invention is to efficiently, effectively and thoroughly process security checks. The process is designed to make the security process for airport clients and workers faster, easier and more secure.

It is another object of the present invention is to reduce the time to move and sort baggage, zone track all baggage from location to location on a real time basis, automatically equate the baggage on the plane to the passengers on the plane.

It is still another object of the present invention is to improve baggage security by tagging and tracking baggage with a high degree of accuracy. A misplaced item would be considered a security violation, causing an investigation and corrective action. Further, as baggage has been accepted for transit and has been associated with a passenger, failure to retrieve the baggage by the checking party or removal by other than the checking party will generate an alarm. This will enhance security and loss prevention.

It is yet a further object of the present invention to require biometrically registered electronic credentials with background check that is retained by the passenger and used to gain daily authorization when entering the air system.

It is still another object of the present invention is to use a private biometric in conjunction with electronic credentials to gain entry to a perimeter and to use public biometrics (human characteristics that are readily visible to the human eye) in identifying individuals within a perimeter.

It is another object of the present invention is to apply differential screening criteria relative to the degree of security needed by individual. The system will be able to discriminate among airport clients, vendors and workers based on pre-assigned security, which shall affect real time trade-offs of security screening and time to process.

It is a further object of the present invention is to review and issue security authorization on a daily or re-entry to the airport zone basis. Every person (passenger, airport employee, pilot, vendor or visitor) that enters the security perimeter of the airport shall be required to receive proper authorization on a daily or re-entry basis.

It is yet a further object of the present invention to maintain security zones continuously and contiguously through the air system. Every individual and item will be monitored as long as the person or item remains in the air system.

It is still a further object of the present invention to publish an exception whenever there is a security breach where an object is missing, in the wrong zone, cannot be verified or cannot be matched (i.e. luggage manifest with boarding passengers). There will be proper electronic warnings (silent and audible as appropriate) when an exception is detected.

It is a further object of the present invention to use layered biometrics, with the primary biometric employed for positive identification and the secondary biometric to minimize fraud, to facilitate the apprehension of anyone attempting to breach the security system, for tracking and automatic assess or denial to designated security zones.

An embodiment of the present invention is a security system for a defined perimeter. Security rules are defined for objects that enter a perimeter wherein an object may be a human object or a property object. A perimeter comprises zones where different security rules apply to different objects. An object enters a perimeter and zones, and traverses zones, based on permissions granted the object. In another embodiment of the present invention, the defined perimeter is Air System comprising a plurality of airports and related facilities.

One embodiment of the present invention applies to air system security beginning when an object enters an air transportation system facility until the object exits the air transportation system. Biometric access is required for human entry. At the point of entry, all security information associated with each object and the code for the day is electronically processed to that object's electronic pass. The electronic pass captures and stores digital information about the object including destination, access permissions, characteristics, identity, level of security and much more. For passengers and their baggage, travel and baggage information is added at the check-in counter until all the information is complete and electronically stored so that all of the objects may proceed through the air system securely and without interference. However, as the object travels through the airport, its progress and location are monitored.

The aforementioned embodiment unobtrusively screen and tracks everything that moves in the air transportation system (pilots, employees, vendors, visitors, baggage, freight and passengers). The system continually eliminates data for objects leaving the air transportation system and refreshes security codes on a daily basis. With respect to this embodiment, the present invention also eliminates passive badges, ramp passes and pin codes that offer little or no real security. There is no need for paper except as a record of travel. The system integrates several technologies that perform the functions discussed below with minimal interference to passengers' travel and privacy.

### BRIEF DESCRIPTION OF THE DRAWINGS

FIG. 1 illustrates a block diagram of an embodiment according to the present invention.

FIG. 2 illustrates three distinct conceptual areas that are affected by the present invention.

FIG. 3 illustrates a trusted registration process according to an embodiment of the present invention.

FIG. 4 illustrates the entering process according to an air transportation system embodiment of the present invention.

FIG. 5 illustrates a data sharing system according to an air transportation system embodiment of the present invention.

### DETAILED DESCRIPTION OF THE INVENTION

An embodiment of the present invention is a security system for a defined perimeter. Security rules are defined for objects that enter a perimeter wherein an object may be a human object or property object. A perimeter comprises zones where different security rules apply to different objects. An object enters a defined perimeter and zones, and traverses zones, based on permissions granted the object. In another embodiment of the present invention, the defined perimeter is an air transportation system comprising a plurality of airports and related facilities. For clarity, this later embodiment will be described in detail. However, as will be appreciated by one skilled in the art of the present invention, the description of this exemplary embodiment is not intended to limit the present invention and other embodiments of the present invention are possible without departing from the scope of the present invention. For example, the present invention may be applied to other transportation systems (e.g., rail transportation) or to the security of a commercial or military facility.

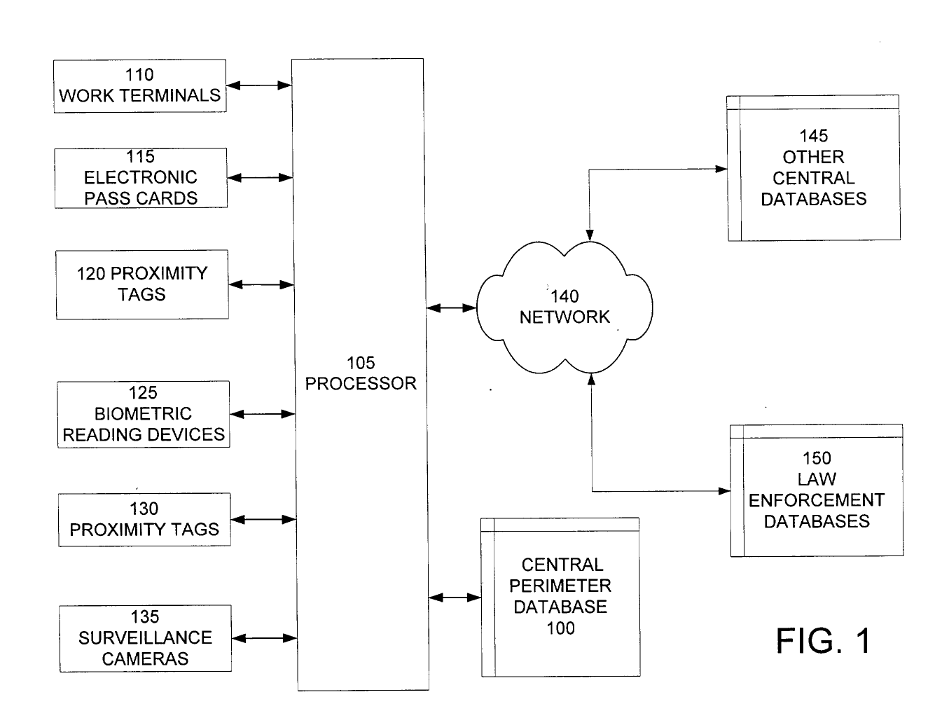

Referring to FIG. 1, a block diagram of an embodiment according to the present invention is illustrated. This embodiment has a central perimeter database 100 and processor 105 in network with work terminals 110, electronic pass cards 115, proximity tags 120, biometric measuring devices 125, scanners and readers to read the digital contents of the passes and proximity tags 130 and surveillance cameras 135. The central perimeter database is also in network with databases throughout the country through network 140. As illustrated, the central perimeter database 100 is communication with other facility databases 145 and law enforcement database 150, but the embodiment is not so limited. Other databases may be connected to central perimeter database 100 without departing from the scope of the present invention.

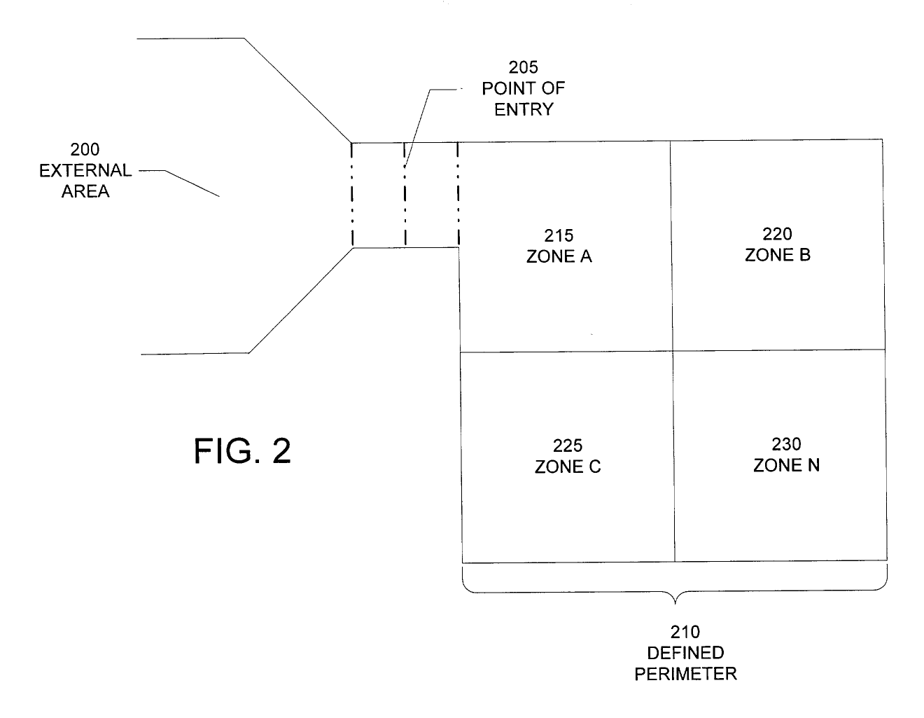

FIG. 2 illustrates three distinct conceptual areas that are affected by the present invention. The defined perimeter 210 is connected by point of entry 205 to external area 200. Defined perimeter 210 comprises zones, illustrated in FIG. 2 as zone A 215, zone B 220, zone C 225, and zone N 230. Defined perimeter 210 is a conceptual depiction. For example, defined perimeter 210 may be a single building or a system of airports in which each airport comprises a zone that is in turn divided into sub-zones.

External area 200 is the first point of contact an object has with the present invention. Unregistered objects that arrive at the external area are offered an opportunity to register with the defined perimeter. Registered objects may be required to obtained electronic credentials prior to arriving at a point of entry. By way of example and not as a limitation, an external area at an airport may comprise a ticket counter. In this embodiment, the human object arriving at a ticket counter at an airport is issued a seat assignment and a set of permissions relating to the zones to he or she may enter once inside the defined perimeter 210. In this embodiment, the permissions are captured and stored on an electronic boarding pass. External area 200 is not required to be proximate to entry point 205 or to defined perimeter 210. For example, external area 200 may be a ticket office located in a city many miles from an airport.

An object desiring to enter the defined perimeter must present the appropriate electronic credentials at point of entry 205. In an embodiment of the present invention, the electronic credentials for human objects are embodied on an electronic pass card and for property objects are embodied on proximity tags, but the concept is same. The electronic pass card will be discussed in more detail below. With respect to a property object, the proximity tag contains information that allows the property object to be associated with a human object owner. The human object is identified by personal information, a private biometric code, and a non-private biometric code, all of which is stored on an electronic pass card. The private biometric code is used to identify the human object to defined perimeter 210 at the point of entry 205. The public biometric code is used to identify and track the human object while within defined perimeter 210.

The present invention is not limited to any particular biometrics. For example, fingerprints, facial geometry, retinal scans, voice recognition, and biometric stress screening may all be utilized without departing from the scope of the present invention. Additionally, other current and future biometric identification technologies, as appropriate, are considered with the scope of the present invention. In one embodiment of the present invention, biometrics are captured using appropriate reading devices and converted to statistically unique biometric codes. When determining whether a proffered biometric matches a filed biometric, the matching process is performed on the biometric codes.

Various embodiments of the present invention distinguish between a private biometric and a public biometric. A private biometric is a biometric that cannot be readily recognized by another individual without the aid of a device. By way of example and not as a limitation, a fingerprint, a retinal scan, an ear geometry scan, and DNA are private biometrics. By contrast, a facial image and facial biometric code are public biometrics.

When an object (human and property) enters an air system perimeter point, proof of identity and verification of identity is accomplished by comparing the private biometric code (e.g. fingerprint code) on the electronic pass card with a generated version of the same biometric captured at the entry point. If the generated version of the biometric code matches the biometric code on the electronic pass card, the object may proceed through the entry point. If an individual is not contained in the database, a temporary air pass is issued for use that day by the individual. Without the background check the individual would not be afforded any security privileges.

While FIG. 2 depicts a single point of entry 205, the present invention is not so limited. As those skilled in the art of the present invention will appreciate, a defined perimeter may have any number of points of entry.

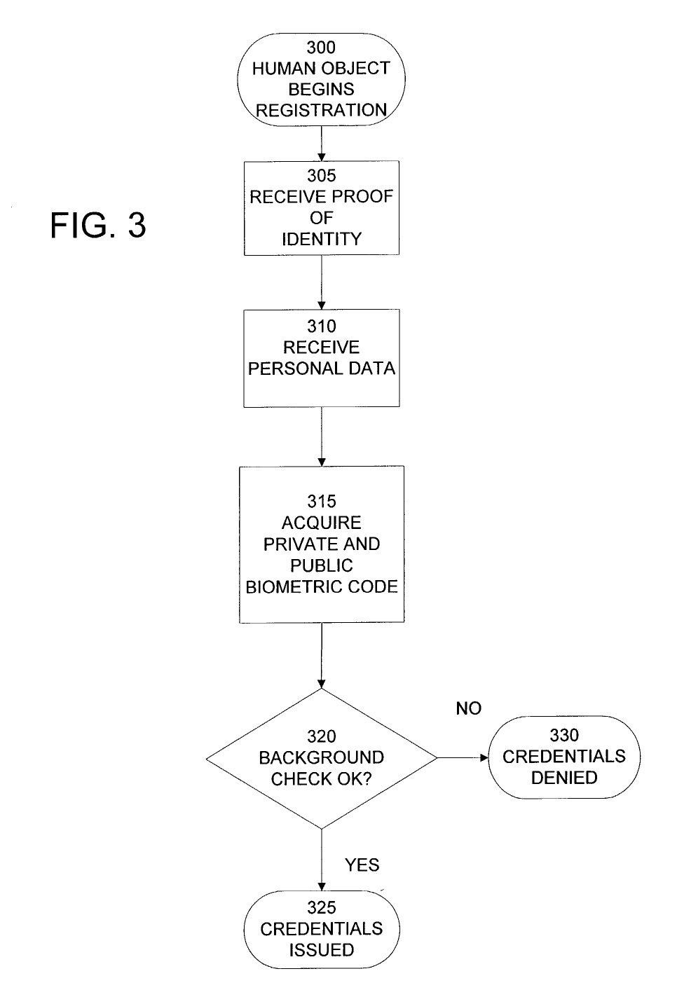

One function that occurs in the external area 200 (e.g., outside of defined perimeter 210) is registration of an unregistered object. With respect to property objects, this process is accomplished by relating the object to its human object owner, or to a trusted third party that acts as a proxy for the human object owner (e.g., a shipping agent). With respect to human objects the registration process is involves data capture and a security check. An embodiment of a registration process is illustrated in FIG. 3.

Referring to FIG. 3, registration begins when an unregistered object arrives at an external area seeking permission to enter a defined perimeter 300. While FIG. 3 illustrates the registration of a human object, the process for a property object is largely the same with exceptions that will be noted below. The registration is a “trusted process” whereby the human object is registered into the system by a trusted and known individual (a “registering agent”). The unregistered human object registers by showing the register agent proof of identity such as a driver's license or passport 305. A physical description and personal data of the unregistered human object are entered into a central perimeter database 310. Next, a private biometric and a public biometric of the unregistered human object are obtained and saved in the form of a biometric code 315. The biometric code comprises a digital code that represents aspects of the biometric to which it relates. In another embodiment, a digital image of a biometric may also be saved.

In an embodiment of the present invention, only the public biometric is save to the central perimeter database. The private biometric is stored only until electronic credentials for the human object can be created. In this embodiment, the electronic credentials comprise an electronic pass card and the private biometric is stored on the electronic pass card along with personal information and security related information. Because the private biometric is stored on the electronic pass card, the electronic pass card in this embodiment is the property of the human object to whom it was issued. The electronic pass card comprises a portable storage medium such as a smart card, active or passive Radio Frequency Identification (RFID) electronic reading circuitry or other appropriate read-write storage device.

A unique code (the database ID) is created for each electronic pass card to prevent fraud. In one embodiment of the present invention, the database ID is associated with a plurality of keys. The keys are used in association with a defined perimeter code and the private biometric code to obtain the human object's public biometric code through a mathematical process. In yet another embodiment of the present invention, the defined perimeter code is a random number that is changed daily and is used to determine which key to use to compute the public biometric code from the private biometric code. In order for a human object's identity to be used fraudulently, a wrong doer would not only have to have access to the human object's private biometric code and database ID, but would have to know the defined perimeter code for a particular day and all of the plurality of keys.

In still another embodiment, the public biometric code is stored on the central perimeter database in association with the database ID assigned to the electronic pass card. In this embodiment, the public biometric code is not stored on the electronic pass card.

The personal data and private and public biometrics are used to perform a background check of the human object 320. A successful registration results in the now registered human object receiving electronic credentials 325. If the background check does not meet established criteria, the human object is denied credentials 330.

In an embodiment of the present invention, the electronic pass card is required to obtain access to a defined perimeter. In this embodiment, the electronic pass card serves as a permanent record of a human object wherein the record comprises personal information (e.g., personal description, address, phone number, social security number, passport number, driver's license number), security information (e.g., a security code and status code), a database ID that can be used to compute a public biometric code, and a private biometric code. Upon initial registration the security code is “blank” and the security status is “temporary”. With the security status set to “temporary”, the human object may use the electronic pass card to gain limited access to the defined perimeter, but may be denied access to various zones with the defined perimeter. The electronic pass card is upgraded to “permanent” status upon successful completion of a background security code of the human object. In one embodiment, the permanent status and security level are automatically entered on the electronic pass card the next time the human object arrives at a point of entry. All information, including the private biometric code, is maintained on the electronic pass card as a permanent record.

In another embodiment of the present invention, not all the electronic credentials are required to be granted entry to a defined perimeter or, once within a defined perimeter, to a zone. In this embodiment, the electronic pass card, the public biometric and the private biometric are “electronic credentials” and access to a defined perimeter or to a zone is based on possession of one or two of these electronic credentials. Additionally, in an alternate embodiment, all information, including the private biometric, are maintained on a central perimeter database. In this embodiment, the private biometric identifies the human object to the defined perimeter so that the electronic pass card is not required to enter the defined perimeter. In still another embodiment, a human object can gain entry to the defined perimeter without that human object's electronic pass card but may not enter specified zones within the defined perimeter. In yet another embodiment, the electronic pass card and the private biometric are required to gain entry to a defined perimeter, but passage to zones requires only possession of the electronic pass card and a match of the public biometric.

By using a private biometric to identify a human object and a public biometric to track and monitor a human object, the multi-layered aspects of the present invention achieve perimeter security with minimal interference to the human object. By way of illustration, an embodiment of the present invention provides security to the air transportation system through the use of electronic pass cards. In this embodiment, private biometric code comprises a fingerprint code and the public biometric code comprises a facial scan code. While a fingerprint is considered a strong authentication metric, facial scans do not meet this standard. However, facial scans can be automated and performed without the human object's direct participation. By combining a strong biometric (fingerprint) with a convenient biometric (facial scan), the present invention not only provides security that is relatively unobtrusive but adds value to otherwise singularly weak biometrics. In an alternate embodiment, entry to air transportation system is based on matching not only the fingerprint code of a human object, but a stored facial code as well. Once entry is granted, tracking and monitoring utilizes a facial code produced at the point of entry.

As noted, property objects require “electronic credentials” to enter a defined perimeter. In an embodiment of the present invention, the credential of a property object comprises a proximity tag. The proximity tag stores information relating to the property object and information relating the property object to one or more human objects. For example, where the defined perimeter is an airport, baggage check-in is performed in a low security zone or an external area. A passenger (a human object) checks luggage (a property object). All of the flight information and passenger's personal information is written to the proximity tag. In an alternate embodiment, the private biometric is also written to the proximity tag. The proximity tag is then used to track the property object through the defined perimeter.

In still another embodiment, freight parcels also receive electronic credentials. Shipper and recipient data are captured on the electronic credentials. In one embodiment, shipper electronic credentials comprise a proximity tag. In another embodiment, the shipper electronic credentials comprise a biometric signature generated from a biometric code of the shipper. In these embodiments, shippers and recipients are certified by verified individuals before the property object will be accepted. If the vouching individual is not registered in the central perimeter database, the property object is inspected. Shipping companies may designate “known” delivery agents on the freight documents or provide an electronic signature that can be automatically scanned.

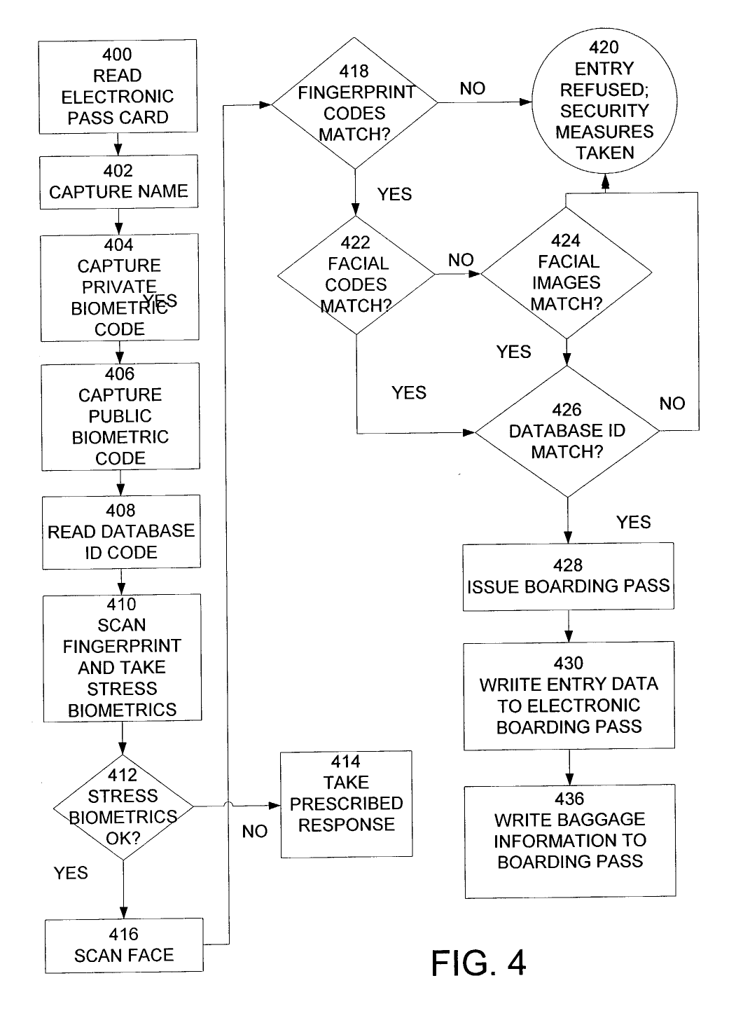

Objects with electronic credentials enter the defined perimeter through a point of entry (See FIG. 1). FIG. 4 illustrates the entering process where the defined perimeter is an air transportation system, the human object is a passenger, the property object is luggage, and the private biometric comprises fingerprints. While the description of this embodiment is specific to an air transportation system, it is not meant to be limiting. Referring to FIG. 4, a registered passenger arrives a point of entry. In this embodiment, this point of entry is the terminal. At the point of entry, the passenger's electronic pass card is read 400 by a digital reader or scanned by a digital scanner. The passenger's name 402, private biometric code 404, and public biometric code 406 are captured by the security system via a biometric reader. The database ID code 408 is also read. The passenger places her finger on the fingerprint scanner and her fingerprint is scanned and stress biometrics taken 410.

The touch pad measures skin and respiratory conditions (e.g., pulse and temperature) to obtain the stress biometrics 410. In an alternate embodiment of the present invention, voice stress is measured by a voice analyzer (not illustrated). The voice analysis system also detects stress indicia. The stress biometrics are analyzed to determine what action, if any, is warranted 412. While stress measurements are not absolute, they are useful data that can translate into security awareness. For example, for a passenger with only one abnormal stress indicator, the response may be to automatically reduce the passenger's security code to one that demands a luggage search and/or a personal scanner search. In another case where multiple passengers on a flight show abnormal stress, security personnel may take respond more aggressively. Based on the rules established by the defined perimeter, if the stress biometrics meet a specified criteria, a prescribed response is taken 414.

The passenger's face is also scanned 416. The scanned fingerprint is converted to fingerprint code and matched against the fingerprint code stored on the electronic pass card 418. If the scanned and store codes do not match, the passenger is not admitted and appropriate security measures are taken 420. If the fingerprint codes match, the scanned facial code is matched against the facial code stored on the electronic pass card 422. If the facial codes match, then the process continues. If the facial codes do not match, the passenger's image is retrieved from the passenger's electronic pass card and a manual comparison is made 424. If the facial images are not matched, the passenger is not admitted and appropriate security measures are taken 420.

In an alternate embodiment, stress biometrics are not acquired.

Continuing, the database ID code as stored on the electronic pass card is then matched against data in the central perimeter database 426. If confirmation is received, entry is permitted. If the data does not match, then the passenger is not admitted and appropriate security measures are taken 420.

The passenger arrives at a ticket counter and receives a “boarding pass” 428. In one embodiment, the boarding pass is a temporary file written to the passenger's electronic pass card. In another embodiment, the boarding pass is a proximity tag. In either embodiment, the boarding pass comprises both active and passive Radio Frequency Identification (RFID) electronic reading circuitry. The active component stores the passenger's name, unique identifier, a daily password, a security zone code and position signal. The passive component stores the passenger's flight information. Returning to FIG. 4, entry data is written to the boarding pass 430. In this embodiment, entry data is retrieved from a central perimeter database and comprises a zone access code, scanned facial image code, a daily digital password, the passenger's destination and all other flight data. Checked baggage information is cross-referenced from the central perimeter database and the data is written to the boarding pass 436. The zone code is not valid except with the daily digital password.

In another embodiment of the present invention, analysis of flight data will be correlated to reveal if several passengers each with low security codes (“low” meaning their access to zones is limited) checked in close in time are seated nearby one another or are seated in strategic locations (front, middle and rear). Further analysis will flag an alarm if several non-related passengers show similar number of flights, proximate home addresses, vicinity seating and other pertinent correlations. At this point the passenger has all the necessary information stored on her boarding pass to permit her to move about the air transportation system and to travel to her departure gate.

In an embodiment of the present invention, a human object's picture (facial image) is captured upon entry to the defined perimeter and converted to a digital code. The digital code of the captured image is compared to the digital code of the facial image stored on the electronic pass card. If the codes match, the human object is identified as known to the defined perimeter. If the codes do not match, then the facial images are matched, either manually or electronically, before an alarm is issued. As new security zones are entered, facial biometric checks are performed against the image captured upon entry to confirm that the bearer of the electronic pass card matches the data stored in the electronic pass card and is authorized to proceed into the next security zone.

In regards to the embodiment of the present invention illustrated in FIG. 4, pilots and flight attendants follow the same procedure as passengers, except these individuals will have different security authorization, and access to different security zones and entry points to the air system. Airlines ticket agents, baggage handlers, contractors, vendors and airport employees also follow the same procedure as passengers except no boarding pass is required and no flight information is stored on the electronic pass card. Like pilots and flight attendants, a different entry point to the air system may be allowed. All visitors will be given a temporary visitor's electronic credentials and will pass through a security checkpoint to be scanned for weapons, explosives or contraband. In one embodiment of present invention, the visitor's facial geometry will be captured and code transferred to the active RFID visitor's electronic credentials along with a security zone code.

Once inside a defined perimeter, every object is tracked. As described previously, electronic credentials are issued for each object entering the defined perimeter. A human object carries an electronic pass card at all time within the defined perimeter. A property object carries a proximity tag at all times within the defined perimeter. Referring to FIG. 2, the defined perimeter comprises zones (215, 220, 225, and 230). Each zone has differing security levels and an objects entitlement to be in a particular zone is determined by the object's zone code. For example a temporary electronic pass card issued to a visitor would have the lowest security authorization while the electronic pass card of an air security agent would have the highest security authorization. In another embodiment of the present invention, property objects comprise baggage and each bag equipped with proximity tag. A bag is tracked from the entry to the baggage processing area, which is a different security zone. When a baggage transport is loaded with baggage, all of the bags on the cart are instantaneously queried for their destination and total count. As the bags enter the baggage compartment of a plane, a reader records the information from each bag. A bag that is not accounted for with the zone of the aircraft will be targeted for security measures.

In an embodiment of the present invention, exception conditions are deduced as to an object's lack of validity in a given zone even though the object has valid access to the specific zone. For example, an object remaining within a zone for an extended period of time may set off a warning alarm under certain conditions. Or, for example, if an object is still in the airport but its flight has departed, then a warning alert would be issued. In another embodiment, an object's security code is changed dynamically to the lowest level based on a determination that the object represents a security risk. The object will then trigger an alarm regardless of where the object is located or what its original security code was.

The electronic credentials of an object comprise the zone access permissions (along with other data) and are readable devices. The electronic credentials are scanned or read and the read data reported to a central perimeter database. In an embodiment of the present invention, each zone within a defined perimeter is equipped with active RFID transmitters and receivers. Electronic credentials queries are done periodically or as necessary. Further, these RFID devices read and write selectively to any electronic credential. Detection of zone violations (i.e. unauthorized entries) is rapidly made and such detection can be recorded on the credentials. In an embodiment where the defined perimeter is an air transportation system, the electronic credentials comprise an electronic pass card and an electronic boarding pass.

An object's whereabouts are monitored until it leaves the defined perimeter. A real time positioning and display system allows the location of any object to be displayed graphically. If an object is not in the correct place or if an unknown object appears in a zone, a warning alert is made allow security personnel to intervene to correct the problem as needed.

Referring again to FIG. 1, a central processor in communication with the central perimeter database uses logic to apply security rules to objects and to detect security violations and suspicious behavior. Upon some threshold event, a warning and alarm is generated.

Security cameras are also employed in monitoring people flow within the defined perimeter. Cameras in association with biometric scanning and discrimination have the capability to identify and track all human objects within a defined perimeter with a high degree of accuracy. Before leaving one zone and entering another a human object's facial picture is scanned and compared to initial facial scan made upon arrival to the point of entry. The human object's electronic credentials are checked for the zone code, unique identifier, daily code and proper flight. A passive proximity reader is used to verify the subject's exact location. It is envisioned that such monitoring can take place without impeding a human object's movement, unless a breach of security has occurred. Additionally, the defined perimeter is under camera surveillance at all security zone interfaces (e.g. when a passenger leaves a waiting area to board the plane). Security camera images will also be incorporated in the security analysis.

The present invention is particularly suited, though not limited to, air transportation facilities. Using the electronic credentials previously described, entry and access to airports can be controlled and rules for entering zones can be enforced. In an embodiment of the present invention, when a passenger arrives at their destination airport, the destination airport is treated as a zone of a larger air transportation system. The passenger's facial codes and flight information are captured and reported to the central perimeter database of the air transportation system. If the daily code of the destination airport differs from the passenger's departing airport, the new daily code is automatically digitally written on the passenger's electronic credentials. No stopping is required.

Pilots and flight attendants use electronic credentials in the same fashion as passengers. Whenever these personnel leave one airport facility and enter another, their air passes are automatically updated to reflect the new location codes and security. Electronic credentials are consistent between airports with respect to formats and security access.

In an embodiment of the present invention, logic is established to generate warning alerts for other than security access violation attempts. For example, an alert may be made if detected biometric stress limits are exceeded (e.g. a person has demonstrated abnormal biometric stress via their finger or voice responses). Or if multiple lesser warnings are accumulated for the same flight. An automatic alert may be generated when a bag is left at the carousel and a companion bag has changed zones. Similarly, an alert be made if the person linked to a bag at the carousel is exiting the air space perimeter without the bag. Many situations can be programmed to trigger an automatic security alert.

With all passengers, pilots, attendants and baggage on the plane, all location information for all objects is complete. The central perimeter database of the air transportation system validates that all people on the plane are authorized and that all baggage matches with the passengers on the plane.

In an embodiment of the invention, objects deplaning are treated as objects moving from one zone (the plane) to another zone (i.e. passenger area or baggage processing). The object's credentials are checked to determine the authority to move into a new zone. The rules of movement are determined by the authority in control of a defined perimeter establishes security rules. By way of illustration, if the enclose perimeter is an airport, one embodiment of the present invention would signal a security alarm if a passenger enters the boarding area zone and subsequently returns to the waiting area

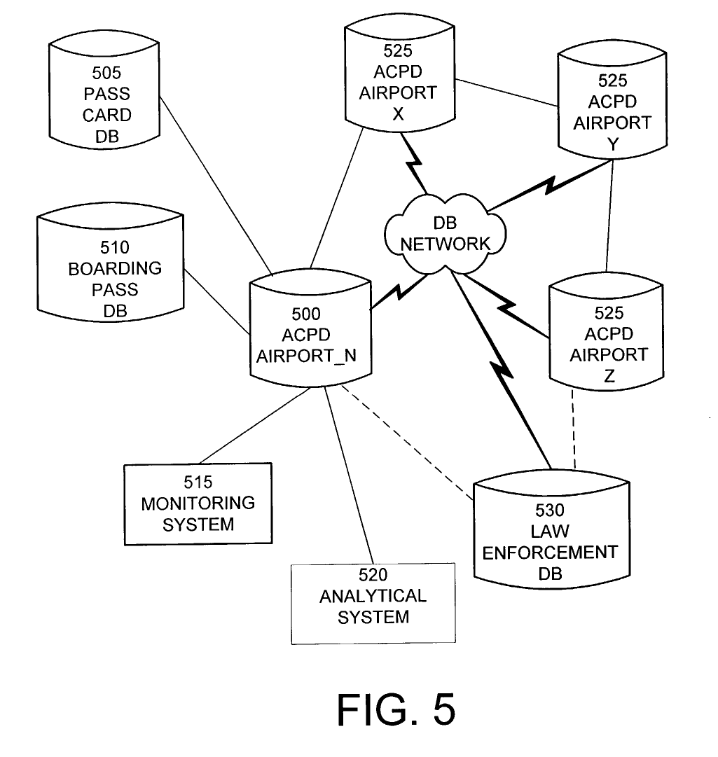

A data sharing system for an air transportation system is illustrated in FIG. 5. A central perimeter database, CPD for airport N 500 is in a local network with the electronic pass card database 505, the boarding pass database 510, work stations (not shown), a monitoring system 515, analytical system 520, video cameras (not shown) and security pass readers (not shown). The central perimeter database 500 is in turn in network with other airport CPD's 525 and law enforcement DB's 530. The data sharing system comprises a substantial database management and analysis system. The system maintains all individual security data, permanent records, flight information, daily passenger flight data, permanent passenger flight records, airline data and baggage data. The system operates all biometric, RFID and surveillance devices (cameras, imaging, scanners, sensors and read/write devices).

The analytical system 520 provides warning of potential security breaches. This system analyzes all the available data and from the results “consistently” detect, alert and subsequently prevent acts of terrorism. For example, the system will deduce that three travelers, starting from different locations, “meeting” at a hub, have a common risk factor and request proximate seating at the rear of the plane. These individuals will get courteous but very different treatment at check in. A specially trained security agent will process these people. Their pulse, temperature and voice stress levels will be silently checked, baggage searched, and other appropriate measures taken by trained professionals. In other cases, the alert and response may simply be a baggage search. In any event the analytical system 520 is capable of analyzing past records and real time data to enhance security awareness.

A system and method for securing a defined perimeter using multi-layered biometric electronic processing has now been illustrated. It will be understood by those skilled in the art of the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

What is claimed is:

1. A method for providing security to a defined perimeter, the defined perimeter having at least one point of entry connecting the defined perimeter to an area external to the defined perimeter, one or more zones internal to the defined perimeter, and a central database that has stored therein a public biometric code associated with an authorized visitor, the method comprising:
receiving at the point of entry from an authorized visitor an electronic credential having stored therein a private biometric code and an identification code;
receiving at a point of entry a private biometric code proffered by an authorized visitor;
making, a first determination whether the proffered private biometric code matches the private biometric code stored in the credential;
in the event the proffered private biometric code matches the private biometric code stored in the credential, acquiring at the point of entry a first instance of a public biometric code;
making, a second determination whether the acquired first instance of the public biometric code matches the public biometric code in the central database associated with the identification code;
in the event the acquired first instance of the public biometric code matches the public biometric code in the central database associated with the identification code;
saving the acquired first instance of the public biometric code to the central database;
assigning the authorized visitor access rights to one or more zones within the defined perimeter;
granting the authorized visitor entry to the defined perimeter;
acquiring at a zone boundary an second instance of the public biometric code;
comparing the acquired second instance of the public biometric code to the acquired first instance of the public biometric code; and
making a third determination whether the authorized visitor has violated the access rights.
